(19) United States
(12) Patent Application Publication
(10) Pub. No.: US 2024/0096143 A1
(43) Pub. Date: Mar. 21, 2024

(54) INFORMATION PROCESSING DEVICE, VEHICLE, AND INFORMATION PROCESSING METHOD

(71) Applicant: TOYOTA JIDOSHA KABUSHIKI KAISHA, Toyota-shi (JP)

(72) Inventors: Yoshihisa YAMADA, Nagoya-shi (JP); Shoji KUBOTA, Nagoya-shi (JP)

(73) Assignee: TOYOTA JIDOSHA KABUSHIKI KAISHA, Toyota-shi (JP)

(21) Appl. No.: 18/215,932

(22) Filed: Jun. 29, 2023

(30) Foreign Application Priority Data
Sep. 15, 2022 (JP) 2022-146973

(51) Int. Cl. G07C 5/02

(52) U.S. Cl. CPC G07C 5/02

(57) ABSTRACT

An information processing device includes one or more processors. The one or more processors are configured to acquire a time lag between the time of occurrence of fluctuation in the rotational speed of a first wheel on the front side of a vehicle and the time of occurrence of fluctuation in the rotational speed of a second wheel on the rear side of the vehicle. The one or more processors are configured to determine the condition of a road surface using the determination result as to whether the fluctuation in the rotational speed of a left wheel of the vehicle and the fluctuation in the rotational speed of a right wheel of the vehicle are synchronized and the time lag.

### CROSS-REFERENCE TO RELATED APPLICATION

This application claims priority to Japanese Patent Application No. 2022-146973 filed on Sep. 15, 2022, incorporated herein by reference in its entirety.

### BACKGROUND

### 1. Technical Field

The present disclosure relates to information processing devices, vehicles, and information processing methods.

### 2. Description of Related Art

A technique of estimating the road surface condition using basic data including vibration data collected by a vehicle is known in the art. For example, Japanese Unexamined Patent Application Publication No. 2018-205970 (JP 2018-205970 A) discloses a technique in which vibration data is used for analysis when the vehicle speed at the detection location of the vibration data is a predetermined value or more, and the vibration data is excluded from analysis when this vehicle speed is less than the predetermined value.

### SUMMARY

JP 2018-205970 A described above discloses a technique in which unsuitable data is separated by selecting whether data is to be used for analysis according to the vehicle speed. However, further improvement is required in order to accurately estimate the road surface condition.

The present disclosure provides an information processing device, vehicle, and information processing method capable of accurately estimating the road surface condition.

An information processing device according to a first aspect of the present disclosure is an information processing device that acquires information on a road surface on which a vehicle travels. The information processing device includes one or more processors. The one or more processors are configured to detect fluctuation in a rotational speed of each wheel of the vehicle. The one or more processors are configured to determine whether the fluctuation in the rotational speed of a left wheel of the vehicle and the fluctuation in the rotational speed of a right wheel of the vehicle are synchronized. The one or more processors are configured to acquire a time lag between time of occurrence of the fluctuation in the rotational speed of a first wheel on a front side of the vehicle and time of occurrence of the fluctuation in the rotational speed of a second wheel on a rear side of the vehicle. The one or more processors are configured to determine a condition of the road surface using the determination result as to whether the fluctuation in the rotational speed of the left wheel of the vehicle and the fluctuation in the rotational speed of the right wheel of the vehicle are synchronized and the time lag.

The fluctuation in the rotational speed of each wheel caused by a bump or irregularity on the road surface is synchronized or linked between the wheels. Therefore, with this configuration, the condition of the road surface can be accurately determined using the determination result as to whether the fluctuation in the rotational speed of the left wheel of the vehicle and the fluctuation in the rotational speed of the right wheel of the vehicle are synchronized and the time lag.

In the information processing device according to the first aspect, the one or more processors may be configured to detect the fluctuation in the rotational speed of each wheel of the vehicle based on one or more signals received from one or more wheel speed sensors configured to detect the rotational speed of each wheel of the vehicle, the one or more signals indicating the rotational speed of each wheel of the vehicle.

In the information processing device according to the first aspect, the one or more processors may be configured to determine time of occurrence of the fluctuation in the rotational speed of the left wheel of the vehicle and time of occurrence of the fluctuation in the rotational speed of the right wheel of the vehicle, based on one or more signals received from one or more wheel speed sensors configured to detect the rotational speed of each wheel of the vehicle, the one or more signals indicating the rotational speed of each wheel of the vehicle. The one or more processors may be configured to determine that the fluctuation in the rotational speed of the left wheel and the fluctuation in the rotational speed of the right wheel are synchronized, when a difference between the time of occurrence of the fluctuation in the rotational speed of the left wheel and the time of occurrence of the fluctuation in the rotational speed of the right wheel is equal to or less than a predetermined threshold.

In the information processing device according to the first aspect, the one or more processors may be configured to determine that the road surface has an irregularity at a position on a trajectory of the first wheel and the second wheel, when the time lag corresponds to a movement period, the movement period being a period required for the vehicle to move a distance equal to a wheelbase of the vehicle.

When the time lag corresponds to the movement period required for the vehicle to move the distance equal to the wheelbase of the vehicle, it means that the fluctuation in the rotational speed of the first wheel and the fluctuation in the rotational speed of the second wheel occur in a linked manner as the wheels pass over an irregularity on the road surface. Therefore, with this configuration, it can be accurately determined that the road surface has an irregularity at a position on the trajectory of the first wheel and the second wheel.

In the information processing device according to the first aspect, the one or more processors may be configured to determine that the road surface has either successive raised areas or successive depressions along the trajectory that are the irregularities, when the rotational speed of the first wheel and the rotational speed of the second wheel continue to fluctuate for a predetermined time or more.

When the rotational speed of the first wheel and the rotational speed of the second wheel continue to fluctuate, it means that the road surface has successive raised areas or successive depressions along the trajectory that are the irregularities. Therefore, with this configuration, it can be accurately determined that the road surface has raised areas or depressions.

In the information processing device according to the first aspect, the one or more processors may be configured to determine that the road surface has a bump extending across the road surface, when the fluctuation in the rotational speed of the left wheel and the fluctuation in the rotational speed of the right wheel are synchronized and the time lag corresponds to a movement period, the movement period being a period required for the vehicle to move a distance equal to a wheelbase of the vehicle.

When the fluctuation in the rotational speed of the left wheel and the fluctuation in the rotational speed of the right wheel are synchronized and the time lag corresponds the movement period required for the vehicle to move the distance equal to the wheelbase of the vehicle, it means that the right and left wheels have passed over a bump extending across the road surface. Therefore, with this configuration, it can be accurately determined whether the road surface has a bump.

In the information processing device according to the first aspect, the one or more processors may be configured to determine that the road surface has undulations composed of a plurality of the bumps, when determination is made more than once that the fluctuation in the rotational speed of the left wheel and the fluctuation in the rotational speed of the right wheel are synchronized and that the time lag corresponds to the movement period.

When determination is made more than once that the road surface has a bump, it means that the road surface has a plurality of bumps. Therefore, with this configuration, it can be accurately determined that the road surface has undulations composed of a plurality of bumps.

The information processing device according to the first aspect may further include a transmission unit configured to send the determined condition of the road surface and location information of the road surface to an external server.

With this configuration, information on the road surface condition can be transmitted to the external server. This can increase the utility value of information on the road surface condition.

A vehicle according to a second aspect of the present disclosure includes one or more wheel speed sensors and one or more processors. The one or more wheel speed sensors are configured to detect a rotational speed of each wheel of the vehicle. The one or more processors are configured to detect fluctuation in the rotational speed of each wheel of the vehicle based on the rotational speed of each wheel received from the one or more wheel speed sensors. The one or more processors are configured to determine whether the fluctuation in the rotational speed of a left wheel of the vehicle and the fluctuation in the rotational speed of a right wheel of the vehicle are synchronized. The one or more processors are configured to acquire a time lag between time of occurrence of the fluctuation in the rotational speed of a first wheel on a front side of the vehicle and time of occurrence of the fluctuation in the rotational speed of a second wheel on a rear side of the vehicle. The one or more processors are configured to determine a condition of the road surface using the determination result as to whether the fluctuation in the rotational speed of the left wheel of the vehicle and the fluctuation in the rotational speed of the right wheel of the vehicle are synchronized and the time lag.

An information communication system according to a third aspect of the present disclosure includes: an information processing device including one or more processors and configured to acquire information on a road surface on which a vehicle travels; and a server configured to manage information sent from the information processing device. The one or more processors included in the information processing device are configured to detect fluctuation in a rotational speed of each wheel of the vehicle. The one or more processors are configured to determine whether the fluctuation in the rotational speed of a left wheel of the vehicle and the fluctuation in the rotational speed of a right wheel of the vehicle are synchronized. The one or more processors are configured to acquire a time lag between time of occurrence of the fluctuation in the rotational speed of a first wheel on a front side of the vehicle and time of occurrence of the fluctuation in the rotational speed of a second wheel on a rear side of the vehicle. The one or more processors are configured to determine a condition of the road surface using the determination result as to whether the fluctuation in the rotational speed of the left wheel of the vehicle and the fluctuation in the rotational speed of the right wheel of the vehicle are synchronized and the time lag.

An information processing method according to (US: a third aspect, CN: a fourth aspect) of the present disclosure is an information processing method for acquiring information on a road surface on which a vehicle travels. The information processing method includes: detecting fluctuation in a rotational speed of each wheel of the vehicle; determining whether the fluctuation in the rotational speed of a left wheel of the vehicle and the fluctuation in the rotational speed of a right wheel of the vehicle are synchronized; acquiring a time lag between time of occurrence of the fluctuation in the rotational speed of a first wheel on a front side of the vehicle and time of occurrence of the fluctuation in the rotational speed of a second wheel on a rear side of the vehicle; and determining a condition of the road surface using the determination result as to whether the fluctuation in the rotational speed of the left wheel of the vehicle and the fluctuation in the rotational speed of the right wheel of the vehicle are synchronized and the time lag.

A non-transitory storage medium according to a fifth aspect of the present disclosure is a non-transitory storage medium storing instructions that are executable by one or more processors and that cause the one or more processors to perform functions. The functions include: detecting fluctuation in a rotational speed of each wheel of a vehicle that travels on a road surface; determining whether the fluctuation in the rotational speed of a left wheel of the vehicle and the fluctuation in the rotational speed of a right wheel of the vehicle are synchronized; acquiring a time lag between time of occurrence of the fluctuation in the rotational speed of a first wheel on a front side of the vehicle and time of occurrence of the fluctuation in the rotational speed of a second wheel on a rear side of the vehicle; and determining a condition of the road surface using the determination result as to whether the fluctuation in the rotational speed of the left wheel of the vehicle and the fluctuation in the rotational speed of the right wheel of the vehicle are synchronized and the time lag.

According to the present disclosure, an information processing device, vehicle, and information processing method that can accurately estimate the road surface condition can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrates an example of the configuration of an information processing system;

FIG. 2 illustrates the configuration of an example of the information processing device according to the present embodiment;

FIG. 3 illustrates an example of a process that is performed by a second processing unit;

FIG. 4 illustrates an example of a process that is performed by a third processing unit;

FIG. 5 is a flowchart showing an example of a process that is performed by a brake electronic control unit (ECU) to determine a road surface having a single irregularity or successive irregularities on the left wheel side;

FIG. 6 is a flowchart showing an example of a process that is performed by the brake ECU to determine a road surface having a single irregularity or successive irregularities on the right wheel side;

FIG. 7 is a flowchart showing an example of a process that is performed by the brake ECU to determine a road surface having a bump or undulations extending across the road surface;

FIG. 8 is a diagram illustrating road surface information;

FIG. 9 is a graph showing an example of a change in rotational speed of each wheel when the road surface has a single roughness on the left wheel side;

FIG. 10 is a graph showing an example of a change in rotational speed of each wheel when the road surface has successive roughnesses on the right wheel side;

FIG. 11 is a graph showing an example of a change in rotational speed of each wheel when the road surface has a bump extending across the road surface;

FIG. 12 is a diagram showing an example of undulations developed on the road surface; and

FIG. 13 is a graph showing an example of a change in rotational speed of each wheel when the road surface has undulations.

### DETAILED DESCRIPTION OF EMBODIMENTS

Hereinafter, an embodiment of the present disclosure will be described in detail with reference to the drawings. The same or corresponding parts are denoted by the same signs throughout the drawings, and description thereof will not be repeated.

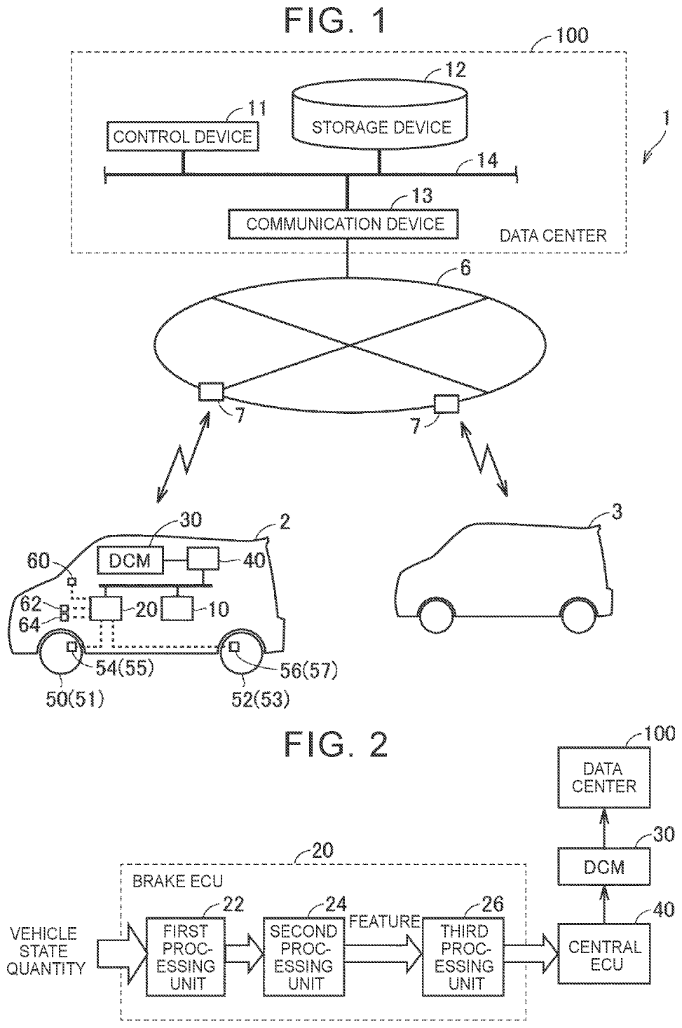

FIG. 1 illustrates an example of the configuration of an information processing system 1. As shown in FIG. 1, in the present embodiment, the information processing system 1 includes a plurality of vehicles 2, 3, a communication network 6, base stations 7, and a data center 100.

The vehicles 2, 3 may be any vehicles capable of communicating with the data center 100. For example, the vehicles 2, 3 may be vehicles using an engine as a driving source, battery electric vehicles using an electric motor as a driving source, or hybrid electric vehicles equipped with an engine and an electric motor and using either or both of the engine and the electric motor as a driving source. Although FIG. 1 shows only two vehicles 2, 3 for convenience of description, the number of vehicles is not particularly limited to two, and may be three or more.

The information processing system 1 is configured to acquire predetermined information from the vehicles 2, 3 configured to communicate with the data center 100, and manage the acquired information.

The data center 100 includes a control device 11, a storage device 12, and a communication device 13. The control device 11, the storage device 12, and the communication device 13 are connected to each other via a communication bus 14 so that these devices 11, 12, and 13 can communicate with each other.

Although not shown in the figure, the control device 11 includes a central processing unit (CPU), a memory (such as a read-only memory (ROM) and a random access memory (RAM)), and an input and output port for inputting and outputting various signals. Various controls that are performed by the control device 11 are implemented by software processing, that is, by the CPU reading a program stored in the memory. The various controls that are performed by the control device 11 can also be implemented by a general-purpose server (not shown) executing a program stored in a storage medium. However, the various controls that are performed by the control device 11 need not necessarily be implemented by the software processing, and may be implemented by processing with dedicated hardware (electronic circuit).

The storage device 12 stores predetermined information on the vehicles 2, 3 configured to communicate with the data center 100. The predetermined information includes, for example, information on a feature that is calculated in each vehicle 2, 3 that will be described later, information identifying each vehicle 2, 3 (hereinafter referred to as vehicle identification (ID)), and information identifying the location of each vehicle 2, 3. The vehicle ID is unique information set for each vehicle. The data center 100 can identify a sender vehicle by the vehicle ID.

The communication device 13 implements bidirectional communication between the control device 11 and the communication network 6. The data center 100 can communicate with a plurality of vehicles including the vehicles 2, 3 via the base stations 7 on the communication network 6 by using the communication device 13.

Next, a specific configuration of the vehicles 2, 3 will be described. Since the vehicles 2, 3 basically have the same configuration, the configuration of the vehicle 2 will be representatively described below.

The vehicle 2 includes a left front wheel 50 and a right front wheel 51 as drive wheels, and a left rear wheel 52 and a right rear wheel 53 as driven wheels. When the left front wheel 50 and the right front wheel 51 are rotated by the operation of the driving source, a driving force acts on the vehicle 2 and the vehicle 2 travels accordingly.

The vehicle 2 further includes an advanced driver assistance system-electronic control unit (ADAS-ECU) 10, a brake ECU 20, a Data Communication Module (DCM) 30, and a central ECU 40.

Each of the ADAS-ECU 10, the brake ECU 20, and the central ECU 40 is a computer including a processor such as a CPU that executes a program, a memory, and an input and output interface.

The ADAS-ECU 10 includes a driver assistance system having functions related to driver assistance of the vehicle 2. The driver assistance system is configured to implement various functions to assist in driving of the vehicle 2 including at least one of the following three controls of the vehicle 2 by running an application installed on the driver assistance system: steering control, drive control, and braking control. Examples of the application installed on the driver assistance system include an application that implements functions of an autonomous driving (AD) system, an application that implements functions of an automated parking system, and an application that implements functions of an advanced driver assistance system (ADAS) (hereinafter referred to as the “ADAS application”).

For example, the ADAS application includes at least one of the following applications: an application that implements functions of vehicle following driving (adaptive cruise control (ACC) etc.) for maintaining a constant following distance to a vehicle ahead, an application that implements functions of auto speed limiter (ASL) for perceiving a speed limit and adapting the maximum speed of the vehicle 2 to the speed limit, an application that implements functions of lane keeping assistance (lane keeping assist (LKA), lane tracing assist (LTA), etc.) for keeping the vehicle 2 within its lane, an application that implements functions of collision damage mitigation braking (autonomous emergency braking (AEB), pre-crash safety (PCS), etc.) for automatically braking the vehicle 2 in order to mitigate damage from a collision, and an application that implements functions of lane deviation warning (lane departure warning (LDW), lane departure alert (LDA), etc.) for alerting a driver of the vehicle 2 when the vehicle 2 is deviating from its lane.

Each application on the driver assistance system outputs to the brake ECU 20 a request for a kinematic plan that guarantees the merchantability (functionality) of the application alone, based on information on the vehicle surroundings acquired (input) from a plurality of sensors, not shown, an assistance request from the driver, etc. Examples of the sensors include a vision sensor such as a forward-facing camera, a radar, a light detection and ranging (LiDAR) sensor, and a location detection device.

Each application acquires, as perceived sensor information, information on the vehicle surroundings obtained by integrating the detection results from one or more sensors, and also acquires an assistance request from the driver via a user interface (not shown) such as a switch. For example, each application can perceive other vehicles, obstacles, or persons around the vehicle by processing, using artificial intelligence (AI) or an image processor, images or videos of the vehicle surroundings acquired by the sensors.

The kinematic plan includes, for example, a request regarding a longitudinal acceleration or deceleration to be generated on the vehicle 2, a request regarding the steering angle of the vehicle 2, and a request regarding holding the vehicle 2 at a stop.

The brake ECU 20 controls a brake actuator that generates a braking force on the vehicle 2 by using the detection results from the sensors. The brake ECU 20 also sets a motion request for the vehicle 2 that fulfills the requests of the kinematic plan from the ADAS-ECU 10. The motion request for the vehicle 2 set by the brake ECU 20 is fulfilled by an actuator system (not shown) mounted on the vehicle 2. The actuator system includes, for example, a plurality of types of actuator systems such as a powertrain system, a brake system, and a steering system.

For example, a first wheel speed sensor 54, a second wheel speed sensor 55, a third wheel speed sensor 56, and a fourth wheel speed sensor 57 are connected to the brake ECU 20.

The first wheel speed sensor 54 detects the rotational speed (number of rotations) of the left front wheel 50 as a wheel speed. The first wheel speed sensor 54 sends a signal indicating the detected rotational speed of the left front wheel 50 to the brake ECU 20.

The second wheel speed sensor 55 detects the rotational speed of the right front wheel 51. The second wheel speed sensor 55 sends a signal indicating the detected rotational speed of the right front wheel 51 to the brake ECU 20.

The third wheel speed sensor 56 detects the rotational speed of the left rear wheel 52. The third wheel speed sensor 56 sends a signal indicating the detected rotational speed of the left rear wheel 52 to the brake ECU 20.

The fourth wheel speed sensor 57 detects the rotational speed of the right rear wheel 53. The fourth wheel speed sensor 57 sends a signal indicating the detected rotational speed of the right rear wheel 53 to the brake ECU 20.

In FIG. 1, the configuration in which the first wheel speed sensor 54, the second wheel speed sensor 55, the third wheel speed sensor 56, and the fourth wheel speed sensor 57 are connected to the brake ECU 20 and directly send the detection results to the brake ECU 20 is illustrated as an example. However, any of the sensors may be connected to other ECU, and the detection results of that sensor may be input to the brake ECU 20 via a communication bus or the central ECU 40.

For example, the brake ECU 20 receives information on the running state of various applications, receives information on other driving operations such as a shift range, receives information on the behavior of the vehicle 2, and receives location information of the vehicle 2, in addition to receiving the information on the kinematic plan from the ADAS-ECU 10.

The DCM 30 is a communication module configured to bidirectionally communicate with the data center 100.

The central ECU 40 is configured to communicate with, for example, the brake ECU 20, and is also configured to communicate with the data center 100 using the DCM 30. For example, the central ECU 40 sends information received from the brake ECU 20 to the data center 100 via the DCM 30.

In the present embodiment, the central ECU 40 is described as an ECU that sends information received from the brake ECU 20 to the data center 100 via the DCM 30. However, for example, the central ECU 40 may be an ECU having a function to relay communication between various ECUs etc. (gateway function), or may be an ECU that includes a memory (not shown) whose stored content can be updated using update information received from the data center 100, and from which predetermined information including update information stored from various ECUs to the memory upon starting of the system of the vehicle 2 is read.

In the vehicle 2 having such a configuration, the brake ECU 20 can, for example, detect the state of change during traveling of the vehicle 2 (e.g., fluctuation in the rotational speed of each wheel) using information obtained from the sensors mounted on the vehicle 2, and estimate the road surface condition using the detection results. For example, such an estimation result of the road surface condition can be used to determine, for example, whether the road surface needs to be repaired. It is therefore desired to accurately estimate the road surface condition.

In the present embodiment, the brake ECU 20 determines the condition of the road surface using the determination result as to whether fluctuation in the rotational speed of the left wheel of the vehicle 2 and fluctuation in the rotational speed of the right wheel of the vehicle 2 are synchronized, and the time lag between the time of occurrence of the fluctuation in the rotational speed of the front wheel of the vehicle 2 and the time of occurrence of the fluctuation in the rotational speed of the rear wheel of the vehicle 2. In the present embodiment, the “right and left wheels” of the vehicle 2 refers to wheels with the same rotation axis, and includes a combination of the left front wheel 50 and the right front wheel 51 and a combination of the left rear wheel 52 and the right rear wheel 53. In the present embodiment, the “front wheel” and “rear wheel” of the vehicle 2 refer to the front and rear wheels on one side, and includes a combination of the left front wheel 50 and the left rear wheel 52 and a combination of the right front wheel 51 and the right rear wheel 53.

Fluctuation in the rotational speed of each wheel caused by a bump or an irregularity on the road surface is synchronized or linked between the wheels. Therefore, the condition of the road surface can be accurately determined by using the determination result as to whether fluctuation in the rotational speed of the right wheel of the vehicle 2 and fluctuation in the rotational speed of the left wheel of the vehicle 2 are synchronized and the time lag therebetween.

FIG. 2 illustrates the configuration of an example of an information processing device according to the present embodiment. The information processing device according to the present embodiment is implemented by the brake ECU 20.

The brake ECU 20 includes a first processing unit 22, a second processing unit 24, and a third processing unit 26. The first processing unit 22 receives information indicating the detection results from various sensors as the information on the behavior of the vehicle 2. The first processing unit 22 outputs to the second processing unit 24 input information received during the period in which a predetermined condition is satisfied out of the period in which the first processing unit 22 receives input information.

The second processing unit 24 calculates a feature related to the operation of the vehicle 2 by using the input information received during the period in which the predetermined condition is satisfied out of the period in which the first processing unit 22 receives input information.

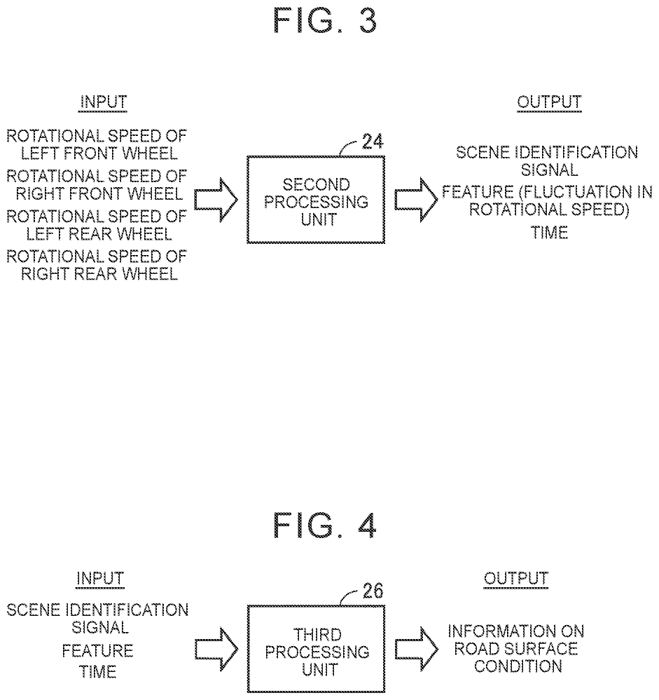

FIG. 3 illustrates an example of a process that is performed by the second processing unit 24. As shown in FIG. 3, the second processing unit 24 receives from the first processing unit 22 the rotational speed of the left front wheel 50, the rotational speed of the right front wheel 51, the rotational speed of the left rear wheel 52, and the rotational speed of the right rear wheel 53 as input information. The second processing unit 24 determines whether the predetermined condition is satisfied by using the input information.

The predetermined condition includes a condition that the rotational speed of each wheel is constant. More specifically, the predetermined condition includes a condition that the amount of change in rotational speed of each wheel during a predetermined period is equal to or less than a threshold.

When the second processing unit 24 determines that the predetermined condition is satisfied, the second processing unit 24 sets a flag indicating that the predetermined condition is satisfied. The second processing unit 24 outputs a signal indicating the state of the flag as a scene identification signal.

When the second processing unit 24 determines that the predetermined condition is satisfied, the second processing unit 24 calculates the feature related to the operation of the vehicle 2 by using the input information received during the period in which the predetermined condition is satisfied.

In the present embodiment, the feature indicates, for example, fluctuation in the rotational speed that occurs according to the road surface condition. In the present embodiment, for example, when such a change in rotational speed of the left front wheel 50 that the difference between its maximum and minimum values during a predetermined period is larger than the threshold occurs after the predetermined condition is satisfied, the second processing unit 24 determines that fluctuation in the rotational speed of the left front wheel 50 occurred during the predetermined period, and outputs this determination result as a feature. That is, for example, when fluctuation in the rotational speed of the left front wheel 50 occurs, the second processing unit 24 sets a flag indicating that fluctuation in the rotational speed of the left front wheel 50 occurred.

For example, the second processing unit 24 also determines for the right front wheel 51, the left rear wheel 52, and the right rear wheel 53 whether fluctuation in the rotational speed occurred by using a similar method, and calculates the determination results (flags corresponding to these wheels and indicating that fluctuation in the rotational speed occurred) as features. For example, when the predetermined condition is satisfied, the second processing unit 24 determines whether fluctuation in the rotational speed of each wheel occurred, and associates each of features indicating the determination results with time, and outputs the scene identification signal and the features each associated with time. The second processing unit 24 repeatedly performs such a process during the period in which the predetermined condition is satisfied.

The third processing unit 26 generates information on the condition of the road surface by using the information output from the second processing unit 24. For example, the third processing unit 26 generates information on the condition of the road surface on which the vehicle 2 travels by using the information output from the second processing unit 24 when the flag included in the scene identification signal is in a predetermined state (e.g., ON).

FIG. 4 illustrates an example of a process that is performed by the third processing unit 26. As shown in FIG. 4, the third processing unit 26 receives information indicating the scene identification signal, the features, and the times from the second processing unit 24. The third processing unit 26 outputs information on the condition of the road surface to the central ECU 40.

The central ECU 40 sends the information received from the third processing unit 26 to the data center 100 via the DCM 30.

The data center 100 determines whether the target road surface is passable for vehicles and whether the target road surface needs repair work, by using the output values from the third processing unit 26.

The information sent from the DCM 30 to the data center 100 includes, for example, processed times, location information of the vehicle, location information of the road surface, and information on the condition of the road surface. Therefore, the data center 100 stores the information received from the DCM 30 in the storage device 12 in such a manner that the processed times, the location information of the vehicle, the location information of the road surface, and the information on the condition of the road surface are one set of data. The data center 100 can thus acquire information on the condition of the road surface on which each of the vehicles 2, 3 that can communicate with the data center 100 travels.

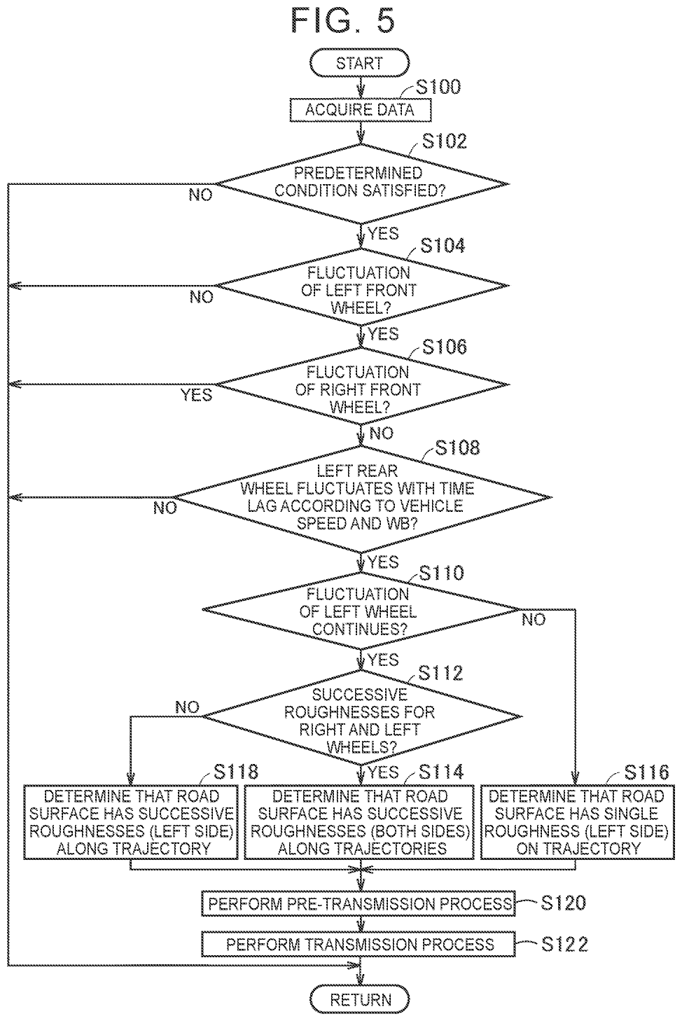

Next, an example of a process that is performed by the brake ECU 20 of the vehicle 2 will be described with reference to FIGS. 5, 6, and 7. FIG. 5 is a flowchart showing an example of a process that is performed by the brake ECU 20 to determine the road surface having a single irregularity or successive irregularities on the left wheel side. A series of steps shown in this flowchart is repeatedly performed by the brake ECU 20 at predetermined control cycles.

In step (hereinafter referred to as “S”) 100, the brake ECU 20 acquires data corresponding to input information. Specifically, the brake ECU 20 acquires data corresponding to input information including, for example, information on the rotational speeds of the left front wheel 50, the right front wheel 51, the left rear wheel 52, and the right rear wheel 53.

In S102, the brake ECU 20 determines whether a predetermined condition is satisfied. The predetermined condition includes a condition that the rotational speed of each wheel has been constant, as described above. Since the determination method is as described above, detailed description thereof will not be repeated. When it is determined that the predetermined condition is satisfied (YES in S102), the process proceeds to S104.

In S104, the brake ECU 20 determines whether there is fluctuation in the rotational speed of the left front wheel 50. Since the method for determining fluctuation is as described above, detailed description thereof will not be repeated. When it is determined that there is fluctuation in the rotational speed of the left front wheel 50 (YES in S104), the process proceeds to S106.

In S106, the brake ECU 20 determines whether there is fluctuation in the rotational speed of the right front wheel 51. The method for determining whether there is fluctuation in the rotational speed of the right front wheel 51 is the same as the method for determining whether there is fluctuation in the rotational speed of the left front wheel 50, detailed description thereof will not be repeated. When it is determined that there is fluctuation in the rotational speed of the right front wheel 51 (YES in S106), the process ends. On the other hand, when it is determined that there is no fluctuation in the rotational speed of the right front wheel 51 (NO in S106), the process proceeds to S108.

In S108, the brake ECU 20 determines whether the rotational speed of the left rear wheel 52 fluctuates with a time lag according to the vehicle speed and the wheelbase (WB). That is, the brake ECU 20 determines whether fluctuation in the rotational speed of the left rear wheel 52 occurred upon the elapse of a movement period from the time of occurrence of the fluctuation in the rotational speed of the left front wheel 50. The movement period is the period required for the vehicle 2 to move the distance equal to the WB.

More specifically, for example, when the magnitude of the difference between the time period from the time of occurrence of the fluctuation in the rotational speed of the left front wheel 50 to the time of occurrence of the fluctuation in the rotational speed of the left rear wheel 52 and the movement period calculated using the vehicle speed and the WB is equal to or less than a threshold, the brake ECU 20 determines that the rotational speed of the left rear wheel 52 fluctuated with the time lag according to the vehicle speed and the WB. The method for determining whether there is fluctuation in the rotational speed of the left rear wheel 52 is the same as the method for determining whether there is fluctuation in the rotational speed of the left front wheel 50, detailed description thereof will not be repeated. When it is determined that the rotational speed of the left rear wheel 52 fluctuated with the time lag according to the vehicle speed and the WB (YES in S108), the process proceeds to S110.

In S110, the brake ECU 20 determines whether the fluctuation in the rotational speed of the left wheel continues. For example, when the range of the fluctuation in the rotational speed (magnitude of the difference between the maximum and minimum values of the rotational speed) of the left front wheel 50 during a predetermined period after the detection of the fluctuation in the rotational speed of the left front wheel 50 is larger than a threshold, the brake ECU 20 determines that the fluctuation in the rotational speed of the left wheel continues. The brake ECU 20 may determine that the fluctuation in the rotational speed of the left wheel continues, when, for example, the range of the fluctuation in the rotational speed of the left rear wheel 52 during the predetermined period after the detection of the fluctuation in the rotational speed of the left rear wheel 52 is larger than the threshold. When it is determined that the fluctuation in the rotational speed of the left wheel continues (YES in S110), the process proceeds to S112.

In S112, the brake ECU 20 determines whether the road surface has successive roughnesses along the trajectories of the right and left wheels. For example, when a flag indicating that the road surface has successive irregularities (hereinafter, “irregularities” is also referred to as “roughnesses”) on the right wheel side is ON, the brake ECU 20 determines that the road surface has successive roughnesses on both the right wheel side and the left wheel side. When it is determined that the road surface has successive roughnesses along the trajectories of the right and left wheels (YES in S112), the process proceeds to S114.

In S114, the brake ECU 20 determines that the road surface has successive roughnesses along the trajectories of the right and left wheels, and sets a flag indicating that the road surface has successive roughnesses on the right and left wheel sides. In this case, the brake ECU 20 clears the flag indicating that the road surface has successive roughnesses on the right wheel side. The process then proceeds to S120. When it is determined that the fluctuation in the rotational speed of the left wheel does not continue (NO in S110), the process proceeds to S116.

In S116, the brake ECU 20 determines that the road surface has a single roughness on the trajectory of the left wheel. In this case, the brake ECU 20 sets a flag indicating that the road surface has a single roughness on the left wheel side. The process then proceeds to S120. On the other hand, when it is determined that the road surface has no successive roughnesses along the trajectories of the right and left wheels (NO in S112), the process proceeds to S118.

In S118, the brake ECU 20 determines that the road surface has successive roughnesses along the trajectory of the left wheel. In this case, the brake ECU 20 sets a flag indicating that the road surface has successive roughnesses on the left wheel side. The process then proceeds to S120. The above steps S100, S102, S104, S106, S108, S110, S112, S114, S116, and S118 are included in the process that is performed by the second processing unit 24.

In S120, the brake ECU 20 performs a pre-transmission process. The brake ECU 20 generates information for the data center 100 to identify the location of the road surface whose condition was determined by the brake ECU 20 and the condition of the road surface at this location. For example, the brake ECU 20 generates road surface information using the above various flags regarding the condition of the road surface. An example of the road surface information that is generated by the brake ECU 20 will be described later. The process then proceeds to S122.

In S122, the brake ECU 20 performs a transmission process. The brake ECU 20 sends the generated information to the central ECU 40. The central ECU 40 sends the received information to the data center 100 via the DCM 30. The above steps S120, S122 correspond to the process that is performed by the third processing unit 26. The process then ends.

When it is determined that there is no fluctuation in the rotational speed of the left front wheel 50 (NO in S104) or when the rotational speed of the left rear wheel 52 does not fluctuate with the time lag according to the vehicle speed and the WB (NO in S108), the process ends.

The data center 100 determines, based on the received information, whether the road surface whose condition was determined is passable for vehicles and whether the road surface has been damaged enough to need restoration, repair, etc. Since the information that is sent to the data center 100 and the process that is performed in the data center 100 are as described above, detailed description thereof will not be repeated. The process then ends.

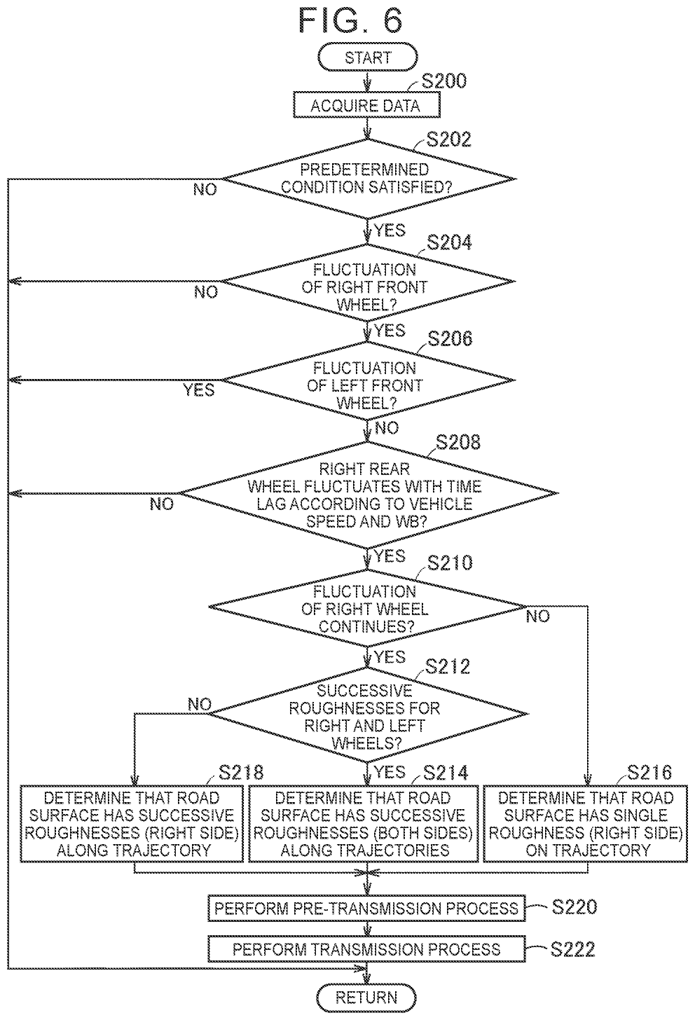

FIG. 6 is a flowchart showing an example of a process that is performed by the brake ECU 20 to determine the road surface having a single irregularity or successive irregularities on the right wheel side. A series of steps shown in this flowchart is repeatedly performed by the brake ECU 20 at predetermined control cycles.

In S200, the brake ECU 20 acquires data corresponding to input information. Since the input information is as described above, detailed description thereof will not be repeated.

In S202, the brake ECU 20 determines whether the predetermined condition is satisfied. Since the predetermined condition and the determination method are as described above, detailed description thereof will not be repeated. When it is determined that the predetermined condition is satisfied (YES in S202), the process proceeds to S204.

In S204, the brake ECU 20 determines whether there is fluctuation in the rotational speed of the right front wheel 51. Since the method for determining whether there is fluctuation in the rotational speed of the right front wheel 51 is as described above, detailed description thereof will not be repeated. When it is determined that there is fluctuation in the rotational speed of the right front wheel 51 (YES in S204), the process proceeds to S206.

In S206, the brake ECU 20 determines whether there is fluctuation in the rotational speed of the left front wheel 50. Since the method for determining whether there is fluctuation in the rotational speed of the left front wheel 50 is as described above, detailed description thereof will not be repeated. When it is determined that there is fluctuation in the rotational speed of the left front wheel 50 (YES in S206), the process ends. On the other hand, when it is determined that there is no fluctuation in the rotational speed of the left front wheel 50 (NO in S206), the process proceeds to S208.

In S208, the brake ECU 20 determines whether the rotational speed of the right rear wheel 53 fluctuates with a time lag according to the vehicle speed and the WB. That is, the brake ECU 20 determines whether fluctuation in the rotational speed of the right rear wheel 53 occurred upon the elapse of a movement period from the time of occurrence of the fluctuation in the rotational speed of the right front wheel 51. The movement period is the period required for the vehicle 2 to move the distance equal to the WB. Since the specific determination method is the same as the above method for determining whether the rotational speed of the left rear wheel 52 fluctuates with the time lag according to the vehicle speed and the WB, detailed description thereof will not be repeated. When it is determined that the rotational speed of the right rear wheel 53 fluctuated with the time lag according to the vehicle speed and the WB (YES in S208), the process proceeds to S210.

In S210, the brake ECU 20 determines whether the fluctuation in the rotational speed of the right wheel continues. Since the method for determining whether the fluctuation in the rotational speed of the right wheel continues is the same as the above method for determining whether the fluctuation in the rotational speed of the left wheel continues, detailed description thereof will not be repeated. When it is determined that the fluctuation in the rotational speed of the right wheel continues (YES in S210), the process proceeds to S212.

In S212, the brake ECU 20 determines whether the road surface has successive roughnesses along the trajectories of the right and left wheels. For example, when the flag indicating that the road surface has successive roughnesses on the left wheel side is ON, the brake ECU 20 determines that the road surface has successive roughnesses on both the right wheel side and the left wheel side. When it is determined that the road surface has successive roughnesses along the trajectories of the right and left wheels (YES in S212), the process proceeds to S214.

In S214, the brake ECU 20 determines that the road surface has successive roughnesses along the trajectories of the right and left wheels, and sets the flag indicating that the road surface has successive roughnesses on the right and left wheel sides. In this case, the brake ECU 20 clears the flag indicating that the road surface has successive roughnesses on the left wheel side. The process then proceeds to S220. When it is determined that the fluctuation in the rotational speed of the right wheel does not continue (NO in S210), the process proceeds to S216.

In S216, the brake ECU 20 determines that the road surface has a single roughness on the trajectory of the right wheel. In this case, the brake ECU 20 sets a flag indicating that the road surface has a single roughness on the right wheel side. The process then proceeds to S220. On the other hand, when it is determined that the road surface has no successive roughnesses along the trajectories of the right and left wheels (NO in S212), the process proceeds to S218.

In S218, the brake ECU 20 determines that the road surface has successive roughnesses along the trajectory of the right wheel. In this case, the brake ECU 20 sets the flag indicating that the road surface has successive roughnesses on the right wheel side. The process then proceeds to S220. The above steps S200, S202, S204, S206, S208, S210, S212, S214, S216, and S218 correspond to the process that is performed by the second processing unit 24.

In S220, the brake ECU 20 performs a pre-transmission process. Since the pre-transmission process is as described above, detailed description thereof will not be repeated. The process then proceeds to S222.

In S222, the brake ECU 20 performs a transmission process. Since the transmission process is as described above, detailed description thereof will not be repeated. The process then ends.

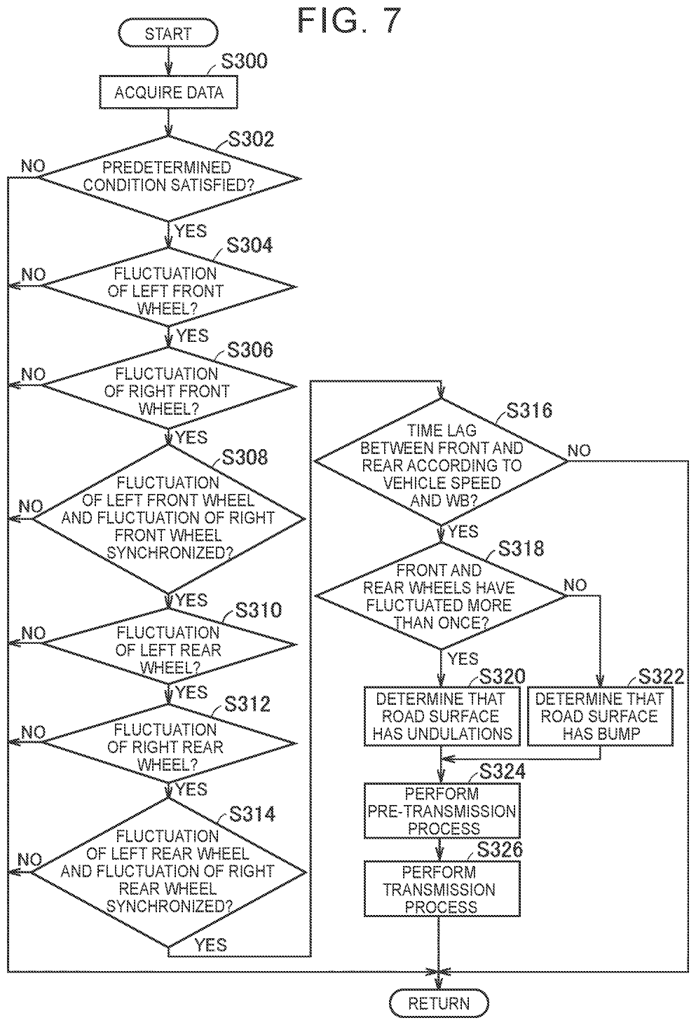

FIG. 7 is a flowchart showing an example of a process that is performed by the brake ECU 20 to determine the road surface having a bump or undulations extending across the road surface. A series of steps shown in this flowchart is repeatedly performed by the brake ECU 20 at predetermined control cycles.

In S300, the brake ECU 20 acquires data corresponding to input information. Since the input information is as described above, detailed description thereof will not be repeated.

In S302, the brake ECU 20 determines whether the predetermined condition is satisfied. Since the predetermined condition and the determination method are as described above, detailed description thereof will not be repeated. When it is determined that the predetermined condition is satisfied (YES in S302), the process proceeds to S304.

In S304, the brake ECU 20 determines whether there is fluctuation in the rotational speed of the left front wheel 50. Since the method for determining whether there is fluctuation in the rotational speed of the left front wheel 50 is as described above, detailed description thereof will not be repeated. When it is determined that there is fluctuation in the rotational speed of the left front wheel 50 (YES in S304), the process proceeds to S306.

In S306, the brake ECU 20 determines whether there is fluctuation in the rotational speed of the right front wheel 51. Since the method for determining whether there is fluctuation in the rotational speed of the right front wheel 51 is as described above, detailed description thereof will not be repeated. When it is determined that there is fluctuation in the rotational speed of the right front wheel 51 (YES in S306), the process proceeds to S308.

In S308, the brake ECU 20 determines whether the fluctuation in the rotational speed of the left front wheel 50 and the fluctuation in the rotational speed of the right front wheel 51 are synchronized. When the difference between the time the fluctuation in the rotational speed of the left front wheel 50 occurred and the time the fluctuation in the rotational speed of the right front wheel 51 occurred is equal to or less than a threshold, the brake ECU 20 determines that the fluctuation in the rotational speed of the left front wheel 50 and the fluctuation in the rotational speed of the right front wheel 51 are synchronized. The time the fluctuation in the rotational speed occurs may be the time the rotational speed reaches its maximum value or the time the rotational speed reaches its minimum value. When it is determined that the fluctuation in the rotational speed of the left front wheel 50 and the fluctuation in the rotational speed of the right front wheel 51 are synchronized (YES in S308), the process proceeds to S310.

In S310, the brake ECU 20 determines whether there is fluctuation in the rotational speed of the left rear wheel 52. Since the method for determining whether there is fluctuation in the rotational speed of the left rear wheel 52 is as described above, detailed description thereof will not be repeated. When it is determined that there is fluctuation in the rotational speed of the left rear wheel 52 (YES in S310), the process proceeds to S312.

In S312, the brake ECU 20 determines whether there is fluctuation in the rotational speed of the right rear wheel 53. Since the method for determining whether there is fluctuation in the rotational speed of the right rear wheel 53 is as described above, detailed description thereof will not be repeated.

In S314, the brake ECU 20 determines whether the fluctuation in the rotational speed of the left rear wheel 52 and the fluctuation in the rotational speed of the right rear wheel 53 are synchronized. The method for determining whether the fluctuation in the rotational speed of the left rear wheel 52 and the fluctuation in the rotational speed of the right rear wheel 53 are synchronized is similar to the method for determining whether the fluctuation in the rotational speed of the left front wheel 50 and the fluctuation in the rotational speed of the right front wheel 51 are synchronized, detailed description thereof will not be repeated. When it is determined that the fluctuation in the rotational speed of the left rear wheel 52 and the fluctuation in the rotational speed of the right rear wheel 53 are synchronized (YES in S314), the process proceeds to S316.

In S316, the brake ECU 20 determines whether there is a time lag between the front and the rear according to the vehicle speed and the WB. That is, the brake ECU 20 determines whether the fluctuation in the rotational speed of the rear wheel occurred upon the elapse of the movement period from the time of occurrence of the fluctuation in the rotational speed of the front wheel. The movement period is the period required for the vehicle 2 to move the distance equal to the WB.

More specifically, for example, when the magnitude of the difference between the time period from the time of occurrence of the fluctuation in the rotational speed of the left wheel (left front wheel 50 or right front wheel 51) to the time of occurrence of the fluctuation in the rotational speed of the rear wheel (left rear wheel 52 or right rear wheel 53) and the movement period calculated using the vehicle speed and the WB is equal to or less than a threshold, the brake ECU 20 determines that there is a time lag between the front and the rear according to the vehicle speed and the WB. When it is determined that there is a time lag between the front and the rear according to the vehicle speed and the WB (YES in S316), the process proceeds to S318.

In S318, the brake ECU 20 determines whether the rotational speed of the front wheel and the rotational speed of the rear wheel have fluctuated more than once. More specifically, the brake ECU 20 determines whether the rotational speed of the front wheel and the rotational speed of the rear wheel have fluctuated more than once while the vehicle 2 travels a predetermined distance. The predetermined distance is, for example, a distance that is set based on the typical length of a bridge etc., and includes, for example, distances in the range of about several meters to about ten-odd meters. When it is determined that the rotational speed of the front wheel and the rotational speed of the rear wheel have fluctuated more than once (YES in S318), the process proceeds to S320.

In S320, the brake ECU 20 determines that the road surface has undulations composed of a plurality of bumps. In this case, the brake ECU 20 sets a flag indicating that the road surface has an undulating shape. The process then proceeds to S324. When it is determined that the rotational speed of the front wheel and the rotational speed of the rear wheel have not fluctuated more than once (have fluctuated only once) (NO in S318), the process proceeds to S322.

In S322, the brake ECU 20 determines that the road surface has a bump extending across the road. In this case, the brake ECU 20 sets a flag indicating that the road surface has a bump. The process then proceeds to S324.

In S324, the brake ECU 20 performs a pre-transmission process. Since the pre-transmission process is as described above, detailed description thereof will not be repeated.

In S326, the brake ECU 20 performs a transmission process. Since the transmission process is as described above, detailed description thereof will not be repeated.

In the pre-transmission process in each of the flowcharts shown in FIGS. 5, 6, and 7, road surface information is generated and associated with location information and time information. The road surface information thus associated with the location information and the time information is sent to the data center 100 in the transmission process.

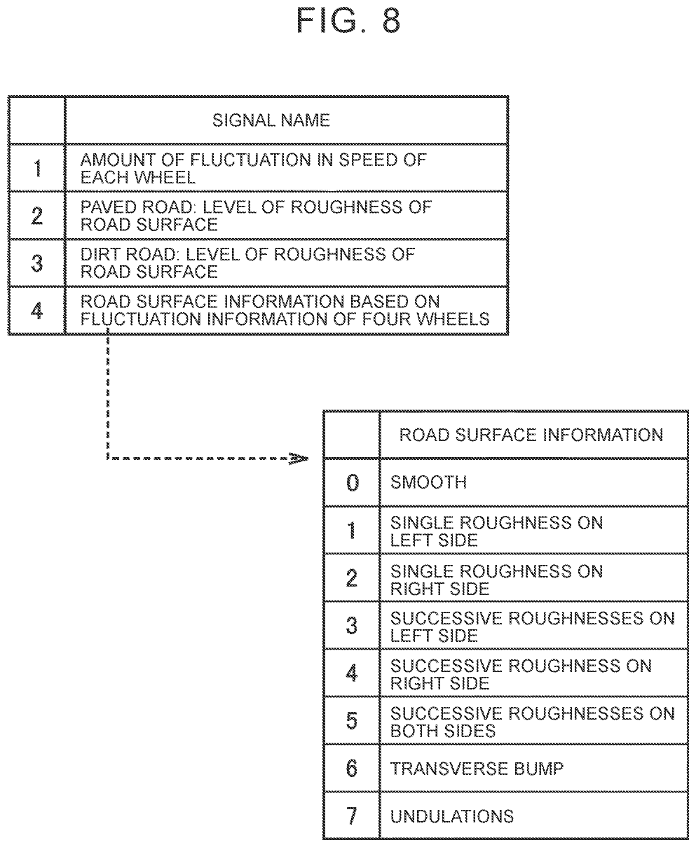

FIG. 8 is a diagram illustrating the road surface information. As shown in FIG. 8, the information that is sent to the data center 100 includes the following information in addition to the location information and time information described above: (1) the amount of fluctuation in the rotational speed of each wheel, (2) the level of roughness of the road surface when the road surface on which the vehicle 2 travels is a paved road, (3) the level of roughness of the road surface when the road surface on which the vehicle 2 travels is a dirt road, and (4) the road surface information based on the fluctuation information of the four wheels. The brake ECU 20 sets, for example, a change history of the rotational speed during the period in which the fluctuation occurs as the above information (1), namely the amount of fluctuation in the rotational speed of each wheel. The brake ECU 20 also determines whether the road surface on which the vehicle 2 travels is a paved road or a dirt road based on the difference in rotational speed between the drive and driven wheels when the vehicle 2 starts to move, information acquired by a camera etc., or map information and location information of the vehicle 2, etc. The brake ECU 20 sets the level of roughness according to the range of the fluctuation in the rotational speed. The brake ECU 20 sets either the above information (2) or (3) according to the determination result of the road surface on which the vehicle 3 travels and the set level of roughness. The road surface information includes (0) smooth, (1) single roughness on the left side, (2) single roughness on the right side, (3) successive roughnesses on the left side, (4) successive roughness on the right side, (5) successive roughnesses on both sides, (6) transverse bump, and (7) undulations. The brake ECU 20 sets the above road surface information using the states of the flags (corresponding to the fluctuation information of the four wheels) set by the processes in the flowcharts shown in FIGS. 5, 6, and 7.

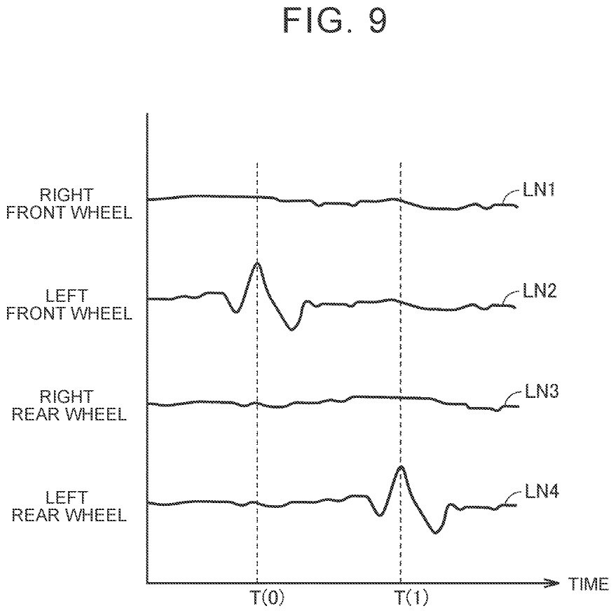

The operation of the brake ECU 20, namely the information processing device according to the present embodiment, based on the above structure and flowcharts will be described with reference to FIGS. 9 to 13.

When the Road Surface has a Single Roughness on the Left Wheel Side

FIG. 9 is a graph showing an example of a change in rotational speed of each wheel when the road surface has a single roughness on the left wheel side. The ordinate in FIG. 9 represents the rotational speed of each wheel. The abscissa in FIG. 9 represents time. LN1 in FIG. 9 indicates a change in rotational speed of the right front wheel 51. LN2 in FIG. 9 indicates a change in rotational speed of the left front wheel 50. LN3 in FIG. 9 indicates a change in rotational speed of the right rear wheel 53. LN4 in FIG. 9 indicates a change in rotational speed of the left rear wheel 52.

As shown by LN1 to LN4 in FIG. 9, when, for example, the vehicle 2 is traveling on a smooth road surface before time T(0), the vehicle 2 continues to travel with the rotational speeds not fluctuating so much. At this time, when the rotational speed of each wheel is detected, the detected rotational speeds are accumulated in the memory of the brake ECU 20 etc. When input information is acquired from the memory (S100), it is determined that the predetermined condition is satisfied (YES in S102).

When the left front wheel 50 passes over a single depression formed in the road surface at time T(0), the rotational speed of the left front wheel 50 temporarily increases and then decreases. Fluctuation with a range equal to or larger than a threshold thus occurs. When there is fluctuation in the rotational speed of the left front wheel 50 (YES in S104) and no fluctuation in the rotational speed of the right front wheel 51 (NO in S106), it is determined whether the rotational speed of the left rear wheel 52 fluctuates with the time lag according to the vehicle speed and the WB (S108).

When the left rear wheel 52 passes over the single depression formed in the road surface at time T(1), namely at the time the vehicle 2 has moved the distance equal to the WB since time T(0), while maintaining the vehicle speed, fluctuation in the rotational speed of the left rear wheel 52 occurs. Therefore, when the fluctuation in the rotational speed of the left rear wheel 52 occurs with the time lag according to the vehicle speed and the WB (YES in S108) and the fluctuation in the rotational speed of the left wheel does not continue thereafter (NO in S110), it is determined that the road surface has a single roughness on the left wheel side (S116). The pre-transmission process is performed to generate road surface information based on this determination result (S120), and the transmission process is performed to send the generated road surface information to the data center 100 (S122).

Such information is also collected from other vehicles. Information for determining whether the road needs to be repaired and whether the road is passable for vehicles, including information on roughness of the road surface, is thus acquired.

When the Road Surface has Successive Roughnesses on the Right Side

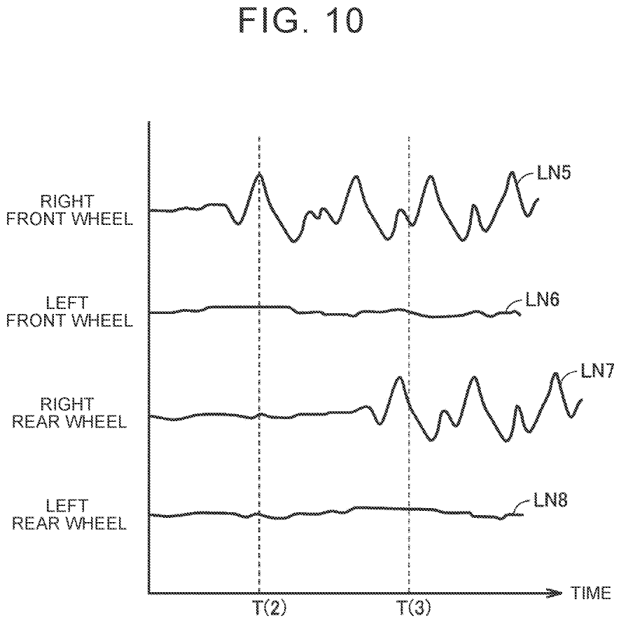

FIG. 10 is a graph showing an example of a change in rotational speed of each wheel when the road surface has successive roughnesses on the right wheel side. The ordinate in FIG. 10 represents the rotational speed of each wheel. The abscissa in FIG. 10 represents time. LN5 in FIG. 10 indicates a change in rotational speed of the right front wheel 51. LN6 in FIG. 10 indicates a change in rotational speed of the left front wheel 50. LN7 in FIG. 10 indicates a change in rotational speed of the right rear wheel 53. LN8 in FIG. 10 indicates a change in rotational speed of the left rear wheel 52.

As shown by LN5 to LN8 in FIG. 10, when, for example, the vehicle 2 is traveling on a smooth road surface before time T(2), the vehicle 2 continues to travel with the rotational speeds not fluctuating so much. At this time, when the rotational speed of each wheel is detected, the detected rotational speeds are accumulated in the memory of the brake ECU 20 etc. When input information is acquired from the memory (S200), it is determined that the predetermined condition is satisfied (YES in S202).

When the right front wheel 51 passes over successive depressions formed in the road surface at time T(2), the rotational speed of the right front wheel 51 temporarily increases and then decreases in a repeated manner. At this time, fluctuation with a range equal to or larger than a threshold occurs. When there is fluctuation in the rotational speed of the right front wheel 51 (YES in S204) and no fluctuation in the rotational speed of the left front wheel 50 (NO in S206), it is determined whether the rotational speed of the right rear wheel 53 fluctuates with the time lag according to the vehicle speed and the WB (S208).

When the right rear wheel 53 passes over the successive depressions formed in the road surface at time T(3), namely at the time the vehicle 2 has moved the distance equal to the WB since time T(2), fluctuation in the rotational speed of the right rear wheel 53 occurs. Therefore, when the fluctuation in the rotational speed of the right rear wheel 53 occurs with the time lag according to the vehicle speed and the WB (YES in S208), the fluctuation in the rotational speed of the right wheel continues thereafter (YES in S210), and the road surface has no successive roughnesses on the left wheel side, it is determined that the road surface has successive roughnesses (depressions) on the right wheel side (S218). The pre-transmission process is performed to generate road surface information based on this determination result (S220), and the transmission process is performed to send the generated road surface information to the data center 100 (S222).

When the Road Surface has a Bump Extending Across the Road Surface

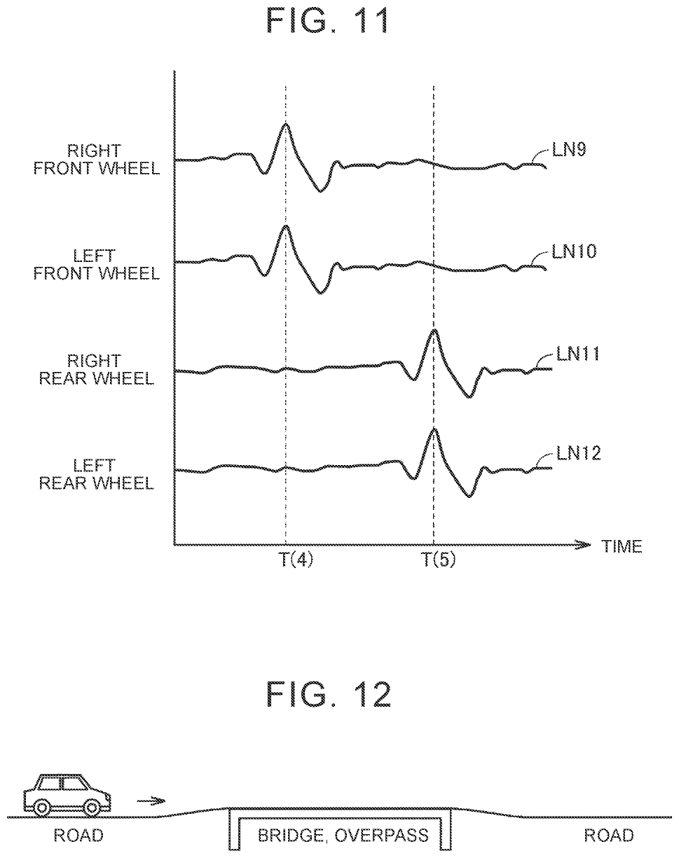

FIG. 11 is a graph showing an example of a change in rotational speed of each wheel when the road surface has a bump extending across the road surface. The ordinate in FIG. 11 represents the rotational speed of each wheel. The abscissa in FIG. 11 represents time. LN9 in FIG. 11 indicates a change in rotational speed of the right front wheel 51. LN10 in FIG. 11 indicates a change in rotational speed of the left front wheel 50. LN11 in FIG. 11 indicates a change in rotational speed of the right rear wheel 53. LN12 in FIG. 11 indicates a change in rotational speed of the left rear wheel 52.

As shown by LN9 to LN12 in FIG. 11, when, for example, the vehicle 2 is traveling on a smooth road surface before time T(4), the vehicle 2 continues to travel with the rotational speeds not fluctuating so much. At this time, when the rotational speed of each wheel is detected, the detected rotational speeds are accumulated in the memory of the brake ECU 20 etc. When input information is acquired from the memory (S300), it is determined that the predetermined condition is satisfied (YES in S302).

When there is fluctuation in the rotational speed of the left front wheel 50 (YES in S304) and there is fluctuation in the rotational speed of the right front wheel 51 (YES in S306) at time T(4), it is determined whether the fluctuation in the rotational speed of the left front wheel 50 and the fluctuation in the rotational speed of the right front wheel 51 are synchronized (S308). Since both the fluctuation in the rotational speed of the left front wheel 50 and the fluctuation in the rotational speed of the right front wheel 51 occur at time T(4), it is determined that the fluctuation in the rotational speed of the left front wheel 50 and the fluctuation in the rotational speed of the right front wheel 51 are synchronized (YES in S308).

When there is fluctuation in the rotational speed of the left rear wheel 52 (YES in S310) and there is fluctuation in the rotational speed of the right rear wheel 53 (YES in S312) at time T(5), namely at the time the vehicle 2 has moved the distance equal to the WB since time T(4), it is determined whether the fluctuation in the rotational speed of the left rear wheel 52 and the fluctuation in the rotational speed of the right rear wheel 53 are synchronized (S314). Since both the fluctuation in the rotational speed of the left rear wheel 52 and the fluctuation in the rotational speed of the right rear wheel 53 occur at time T(5), it is determined that the fluctuation in the rotational speed of the left rear wheel 52 and the fluctuation in the rotational speed of the right rear wheel 53 are synchronized (YES in S314).

Since the time lag between the time of occurrence of the fluctuation in the rotational speed of the left front wheel 50 and the time of occurrence of the fluctuation in the rotational speed of the left rear wheel 52 is the time lag between the front and the rear according to the vehicle speed and the WB (YES in S316), it is determined whether the rotational speed of the front wheel and the rotational speed of the rear wheel have fluctuated more than once (S318). When no fluctuation in the rotational speed is detected for the front and rear wheels after time T(5), it is determined that the rotational speed of the front wheel and the rotational speed of the rear wheel have not fluctuated more than once (NO in S318), and it is therefore determined that the road surface has a bump extending across the road surface (S322). The pre-transmission process is performed to generate road surface information based on this determination result (S324), and the transmission process is performed to send the generated road surface information to the data center 100 (S326).

When the Road Surface has Undulations

FIG. 12 is a diagram showing an example of undulations developed on the road surface. As shown in FIG. 12, when the travel route of the vehicle 2 has a section that serves as a bridge or an overpass, a plurality of bumps may be developed immediately before or after the section. An approach slab is installed immediately before or after the section. Therefore, a bump is developed in the boundary portion between the approach stab and the bridge or overpass as the road deteriorates. Such bumps form undulations on the road surface.

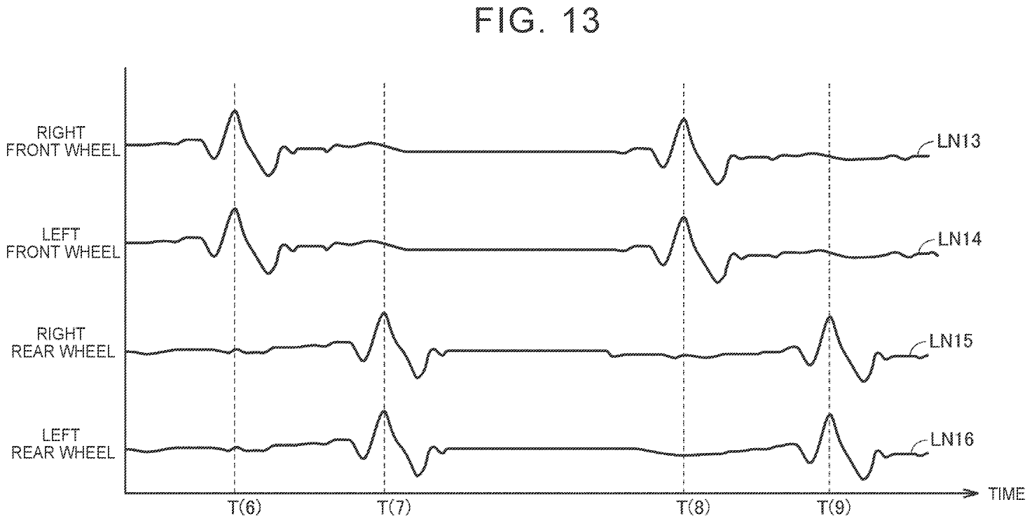

FIG. 13 is a graph showing an example of a change in rotational speed of each wheel when the road surface has undulations. The ordinate in FIG. 13 represents the rotational speed of each wheel. The abscissa in FIG. 13 represents time. LN13 in FIG. 13 indicates a change in rotational speed of the right front wheel 51. LN14 in FIG. 13 indicates a change in rotational speed of the left front wheel 50. LN15 in FIG. 13 indicates a change in rotational speed of the right rear wheel 53. LN16 in FIG. 13 indicates a change in rotational speed of the left rear wheel 52.

As shown by LN13 to LN16 in FIG. 13, when, for example, the vehicle 2 is traveling on a smooth road surface before time T(6), the vehicle 2 continues to travel with the rotational speeds not fluctuating so much. At this time, when the rotational speed of each wheel is detected, the detected rotational speeds are accumulated in the memory of the brake ECU 20 etc. When input information is acquired from the memory (S300), it is determined that the predetermined condition is satisfied (YES in S302).

When there is fluctuation in the rotational speed of the left front wheel 50 (YES in S304) and there is fluctuation in the rotational speed of the right front wheel 51 (YES in S306) at time T(6), it is determined whether the fluctuation in the rotational speed of the left front wheel 50 and the fluctuation in the rotational speed of the right front wheel 51 are synchronized (S308). Since both the fluctuation in the rotational speed of the left front wheel 50 and the fluctuation in the rotational speed of the right front wheel 51 occur at time T(6), it is determined that the fluctuation in the rotational speed of the left front wheel 50 and the fluctuation in the rotational speed of the right front wheel 51 are synchronized (YES in S308).

When there is fluctuation in the rotational speed of the left rear wheel 52 (YES in S310) and there is fluctuation in the rotational speed of the right rear wheel 53 (YES in S312) at time T(7), namely at the time the vehicle 2 has moved the distance equal to the WB since time T(6), it is determined whether the fluctuation in the rotational speed of the left rear wheel 52 and the fluctuation in the rotational speed of the right rear wheel 53 are synchronized (S314). Since both the fluctuation in the rotational speed of the left rear wheel 52 and the fluctuation in the rotational speed of the right rear wheel 53 occur at time T(7), it is determined that the fluctuation in the rotational speed of the left rear wheel 52 and the fluctuation in the rotational speed of the right rear wheel 53 are synchronized (YES in S314).

Since the time lag between the time of occurrence of the fluctuation in the rotational speed of the left front wheel 50 and the time of occurrence of the fluctuation in the rotational speed of the left rear wheel 52 is the time lag between the front and the rear according to the vehicle speed and the WB (YES in S316), it is determined whether the rotational speed of the front wheel and the rotational speed of the rear wheel have fluctuated more than once (S318). When fluctuation in the rotational speed is detected for the front and rear wheels at time T(8) and time T(9) after time T(7), it is determined that the rotational speed of the front wheel and the rotational speed of the rear wheel have fluctuated more than once (YES in S318), and it is therefore determined that the road surface has undulations (S320). The pre-transmission process is performed to generate road surface information based on this determination result (S324), and the transmission process is performed to send the generated road surface information to the data center 100 (S326).

As described above, according to the information processing device of the present embodiment, fluctuation in the rotational speed of each wheel caused by a bump or a roughness such as an irregularity on the road surface is synchronized or linked between the wheels. Therefore, the condition of the road surface can be accurately determined by using the determination result as to whether fluctuation in the rotational speed of the right wheel of the vehicle 2 and fluctuation in the rotational speed of the left wheel of the vehicle 2 are synchronized and the time lag therebetween. An information processing device, vehicle, information processing system, information processing method, and non-transitory storage medium that can accurately estimate the road surface condition can thus be provided.

When the rotational speed of the wheel continues to fluctuate after the fluctuation occurs, it means that the vehicle continues to travel over successive depressions or raised areas that are irregularities, it can be accurately determined that the road surface is in such a condition that irregularities are present along the trajectory of the wheel.

When fluctuation in the rotational speed of the right wheel and fluctuation in the rotational speed of the left wheel are synchronized, it means that the right and left wheels passed over a bump extending across the road surface. Therefore, it can be accurately determined that the road surface has a bump formed across the road surface.

When it is determined more than once that the road surface has a bump, it can be accurately determined that the road surface has undulations composed of a plurality of bumps.

Moreover, information on the condition of the road surface (road surface information) that is valuable to the user can be calculated while being concealed so that the individual cannot be identified.

Since the DCM 30 that is a transmission unit can send information on the condition of the road surface (road surface information) for determining whether the road surface needs to be repaired to the outside of the vehicle, the utility value of the road surface information can be increased.

Moreover, when the feature is calculated in the vehicle, it is not necessary to send information for calculating the feature to the outside of the vehicle. This reduces transmission of unnecessary information to the outside of the vehicle when, for example, the amount of information for calculating the feature is large, and thus reduces an increase in communication load and reduces the storage capacity of the data center 100 and processing cost for the data center 100.

In addition, since calculation of the feature and calculation of the change history of the feature are separately performed by the second processing unit 24 and the third processing unit 26, only the method for calculating the change history of the feature that is performed by the third processing unit 26 can be changed and used to generate other road surface information. This change of the method for calculating the change history of the feature can be implemented by, for example, the brake ECU 20 reading the update information received from the data center 100 and stored in the memory of the central ECU 40.

Modifications will be described below.

The above embodiment illustrates an example in which the input information input to the brake ECU 20 is subjected to the processes of the flowcharts of FIGS. 5, 6, and 7 inside the brake ECU 20 to perform calculation of the feature and calculation of the change history of the feature. However, these processes may be performed in the data center 100.

The above embodiment illustrates an example in which the vehicle 2 is a vehicle with four wheels. However, the vehicle 2 may be a vehicle with more than four wheels.

A part or all of the above modifications may be combined as appropriate.

The embodiment disclosed herein should be construed as illustrative in all respects and not restrictive. The scope of the present disclosure is shown by the claims rather than by the above description and is intended to include all modifications within the meaning and scope equivalent to the claims.

What is claimed is:

1. An information processing device that acquires information on a road surface on which a vehicle travels, the information processing device comprising one or more processors configured to
detect fluctuation in a rotational speed of each wheel of the vehicle,
determine whether the fluctuation in the rotational speed of a left wheel of the vehicle and the fluctuation in the rotational speed of a right wheel of the vehicle are synchronized,
acquire a time lag between time of occurrence of the fluctuation in the rotational speed of a first wheel on a front side of the vehicle and time of occurrence of the fluctuation in the rotational speed of a second wheel on a rear side of the vehicle, and
determine a condition of the road surface using the determination result as to whether the fluctuation in the rotational speed of the left wheel of the vehicle and the fluctuation in the rotational speed of the right wheel of the vehicle are synchronized and the time lag.

2. The information processing device according to claim 1, wherein the one or more processors are configured to detect the fluctuation in the rotational speed of each wheel of the vehicle based on one or more signals received from one or more wheel speed sensors configured to detect the rotational speed of each wheel of the vehicle, the one or more signals indicating the rotational speed of each wheel of the vehicle.

3. The information processing device according to claim 1, wherein the one or more processors are configured to
determine time of occurrence of the fluctuation in the rotational speed of the left wheel of the vehicle and time of occurrence of the fluctuation in the rotational speed of the right wheel of the vehicle, based on one or more signals received from one or more wheel speed sensors configured to detect the rotational speed of each wheel of the vehicle, the one or more signals indicating the rotational speed of each wheel of the vehicle, and
determine that the fluctuation in the rotational speed of the left wheel and the fluctuation in the rotational speed of the right wheel are synchronized, when a difference between the time of occurrence of the fluctuation in the rotational speed of the left wheel and the time of occurrence of the fluctuation in the rotational speed of the right wheel is equal to or less than a predetermined threshold.

4. The information processing device according to claim 1, wherein the one or more processors are configured to determine that the road surface has an irregularity at a position on a trajectory of the first wheel and the second wheel, when the time lag corresponds to a movement period, the movement period being a period required for the vehicle to move a distance equal to a wheelbase of the vehicle.

5. The information processing device according to claim 4, wherein the one or more processors are configured to determine that the road surface has either successive raised areas or successive depressions along the trajectory that are the irregularities, when the rotational speed of the first wheel and the rotational speed of the second wheel continue to fluctuate for a predetermined time or more.

6. The information processing device according to claim 1, wherein the one or more processors are configured to determine that the road surface has a bump extending across the road surface, when the fluctuation in the rotational speed of the left wheel and the fluctuation in the rotational speed of the right wheel are synchronized and the time lag corresponds to a movement period, the movement period being a period required for the vehicle to move a distance equal to a wheelbase of the vehicle.

7. The information processing device according to claim 6, wherein the one or more processors are configured to determine that the road surface has undulations composed of a plurality of the bumps, when determination is made more than once that the fluctuation in the rotational speed of the left wheel and the fluctuation in the rotational speed of the right wheel are synchronized and that the time lag corresponds to the movement period.

8. The information processing device according to claim 1, further comprising a transmission unit configured to send the determined condition of the road surface and location information of the road surface to an external server.

9. A vehicle, comprising:
one or more wheel speed sensors configured to detect a rotational speed of each wheel of the vehicle; and
one or more processors configured to
detect fluctuation in the rotational speed of each wheel of the vehicle based on the rotational speed of each wheel received from the one or more wheel speed sensors,
determine whether the fluctuation in the rotational speed of a left wheel of the vehicle and the fluctuation in the rotational speed of a right wheel of the vehicle are synchronized,
acquire a time lag between time of occurrence of the fluctuation in the rotational speed of a first wheel on a front side of the vehicle and time of occurrence of the fluctuation in the rotational speed of a second wheel on a rear side of the vehicle, and
determine a condition of a road surface using the determination result as to whether the fluctuation in the rotational speed of the left wheel of the vehicle and the fluctuation in the rotational speed of the right wheel of the vehicle are synchronized and the time lag.

10. An information processing method for acquiring information on a road surface on which a vehicle travels, the information processing method comprising:
detecting fluctuation in a rotational speed of each wheel of the vehicle;
determining whether the fluctuation in the rotational speed of a left wheel of the vehicle and the fluctuation in the rotational speed of a right wheel of the vehicle are synchronized;
acquiring a time lag between time of occurrence of the fluctuation in the rotational speed of a first wheel on a front side of the vehicle and time of occurrence of the fluctuation in the rotational speed of a second wheel on a rear side of the vehicle; and
determining a condition of the road surface using the determination result as to whether the fluctuation in the rotational speed of the left wheel of the vehicle and the fluctuation in the rotational speed of the right wheel of the vehicle are synchronized and the time lag.
